(19) United States
(12) Patent Application Publication
(10) Pub. No.: US 2010/0148011 A1
(43) Pub. Date: Jun. 17, 2010

(54) TELESCOPING STRUCTURE AND METHOD

(76) Inventor: Terry M. Sanderson, Tucson, AZ (US)

Correspondence Address: Renner, Otto, Boisselle & Sklar, LLP (Raytheon), 1621 Euclid Avenue - 19th Floor, Cleveland, OH, 44115, US

(21) Appl. No.: 12/616,806

(22) Filed: Nov. 12, 2009

Related U.S. Application Data
(60) Provisional application No. 61/113,694, filed on Nov. 12, 2008.

(51) Int. Cl. B64C 3/54; E04H 12/18; E04G 25/04

(52) U.S. Cl. 244/218; 52/741.1; 52/632

(57) ABSTRACT

A telescoping structure includes an alignment mechanism to keep aligned an inner structure member and outer structure member, as the members translate relative to one another to extend or retract the telescoping structure. The alignment mechanism includes multiple parts that are mechanically coupled to respective of the structure members. For example, the alignment mechanism may include sprockets or pinions (rotating, toothed elements) on one of the structure members that engage racks or chains (linear, tooth-receiving elements having recesses therein) on the other of the structure members. By keeping the telescoping structure members in alignment with other during telescoping translation, jamming is prevented or at least made less likely. The parts of the alignment mechanism may also be used to provide force for extending or retracting the telescoping structure, for example using a motor move the tooth elements and/or the tooth-receiving elements to cause relative translation of the structure members.

This application claims priority under 35 USC 119 to U.S. Provisional Application No. 61/113,694, filed Nov. 12, 2008, which is incorporated by reference herein in its entirety.

### BACKGROUND OF THE INVENTION

1. Field of the Invention

The invention is in the field of telescoping structures and methods for extending and retracting such structures.

2. Description of the Related Art

Telescoping structures have a tendency to bind and perhaps jam when extended and retracted. It would be better if they did not bind and perhaps jam.

### SUMMARY OF THE INVENTION

Telescoping structures may be used to extend and retract aerospace structures, such as satellites and aircraft wings, as well as a wide variety of other structures. Various methods are used to extend and retract telescoping structures without binding and jamming, or at least in reducing the likelihood of such binding and jamming. Various elements, such as gears, cables, racks, pinions, and chains, may be used to keep the parts aligned during extension and retractions.

According to an aspect of the invention, a telescoping structure includes an alignment mechanism to keep its members aligned as they extend or retract.

According to another aspect of the invention, a telescoping structure includes: an outer structure member; an inner structure member at least partially within the outer structure member, wherein the outer structural member is translatable in a longitudinal direction relative to the outer structural member in order to extend and retract the structure; and an alignment mechanism that is mechanically coupled to the structure members. The alignment mechanism is at least partially within the outer structural member. The alignment mechanism maintains relative alignment of the structural members about a longitudinal axis of the telescoping structure that extends in the longitudinal direction, as the structure is extended and retracted.

According to yet another aspect of the invention, a method of extending a telescoping structure includes the steps of: moving an outer structure member of the structure relative to an inner structure member of the structure; and while doing the moving, using an alignment mechanism of the structure to keep the structure members aligned.

According to still another aspect of the invention, an aircraft wing includes: a morphing polymer foam body having a cavity therein; and a telescoping structure located within the cavity. The telescoping structure includes: an outer structure member; an inner structure member at least partially within the outer structure member, wherein the outer structural member is translatable in a longitudinal direction relative to the outer structural member in order to extend and retract the structure; and an alignment mechanism that is mechanically coupled to the structure members. The alignment mechanism is at least partially within the outer structural member. The alignment mechanism maintains relative alignment of the structural members about a longitudinal axis of the telescoping structure that extends in the longitudinal direction, as the structure is extended and retracted.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is an oblique view of an aircraft that includes a telescoping structure in accordance with an embodiment of the present invention, with the aircraft in a short-wingspan configuration.

FIG. 2 is a top view of the aircraft of FIG. 1, in the configuration shown in FIG. 1.

FIG. 3 is an oblique view of the aircraft of FIG. 1, in a long-wingspan configuration.

FIG. 4 is a top view of the aircraft of FIG. 3, in the configuration shown in FIG. 3.

FIG. 5 is an oblique view of a telescoping structure according to an embodiment of the invention.

FIG. 6 is a schematic view of the telescoping structure of FIG. 5, in a retracted position.

FIG. 7 is a schematic view of the telescoping structure of FIG. 5, in an extended position.

FIG. 8 is a cross-sectional view of an aircraft wing that has a cavity for receiving a telescoping structure, in accordance with an embodiment of the invention.

FIG. 9 is a schematic view of another embodiment telescoping structure according to the present invention.

FIG. 10 is a schematic view of yet another embodiment telescoping structure according to the present invention.

FIG. 11 is a schematic view of still another embodiment telescoping structure according to the present invention.

FIG. 12 is a side view of a chain used in the structure of FIG. 11.

FIG. 13 is a top view of the chain of FIG. 12.

FIG. 14 is a schematic view of a further embodiment telescoping structure according to the present invention.

### DETAILED DESCRIPTION

A telescoping structure includes an alignment mechanism to keep aligned an inner structure member and outer structure member, as the members translate relative to one another to extend or retract the telescoping structure. The alignment mechanism includes multiple parts that are mechanically coupled to respective of the structure members. For example, the alignment mechanism may include sprockets or pinions (rotating, toothed elements) on one of the structure members that engage racks or chains (linear, tooth-receiving elements having recesses therein) on the other of the structure members. By keeping the telescoping structure members in alignment with each other during telescoping translation, jamming is prevented or at least made less likely. The parts of the alignment mechanism may also be used to provide force for extending or retracting the telescoping structure, for example using a motor to move the tooth elements and/or the tooth-receiving elements to cause relative translation of the structure members.

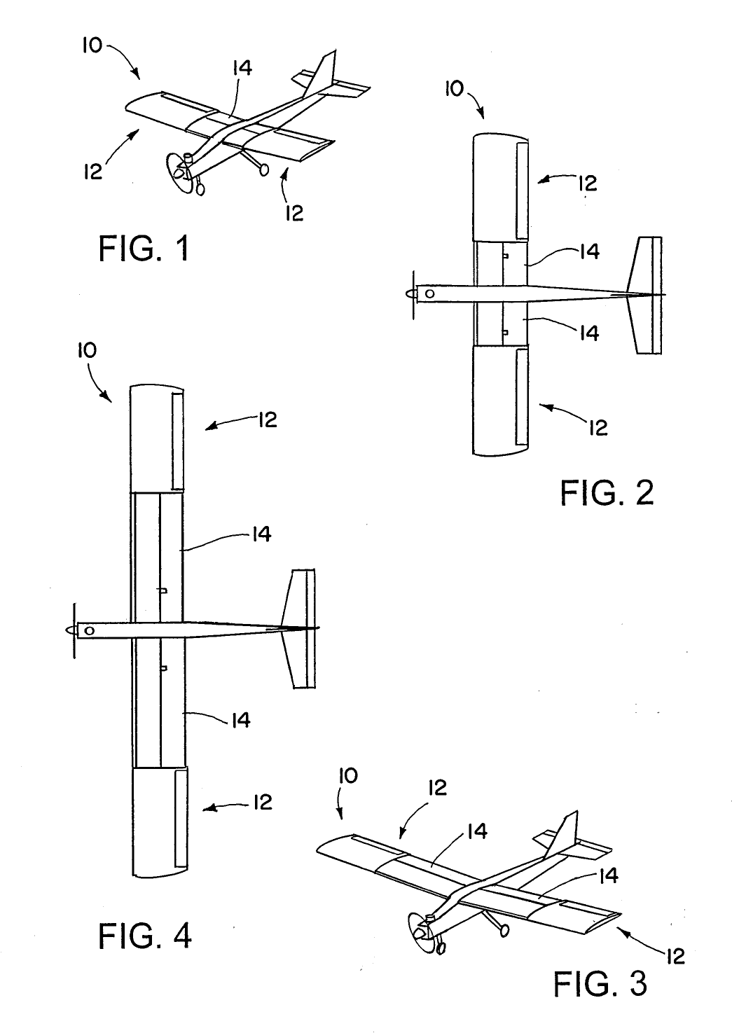

FIGS. 1-4 show various views of an aircraft 10 with an extendible wing 12 structure. The wings 12 of the aircraft 10 may have their span selectively increased and decreased. A telescoping structure of the wings 10 may be overlaid with a flexible material 14 that can undergo a large strain, such as an extension of 400%, without rupturing. Such a material may be termed a “morphing skin.” An example of such a material is polymer foam, for example a shape memory polymer foam. The polymer foam may be coated with a solid polymer material, for example being made of the same material as the foam, but without the voids that characterize the foam. The following pending applications, the descriptions and figures of which are incorporated herein by reference, describe examples of use of such foams (and other materials), with and without underlying structures: U.S. application Ser. No. 11/670,736, filed Feb. 2, 2007; U.S. application Ser. No. 12/120,271, filed May 14, 2008; U.S. application Ser. No. 12/120,273, filed May 14, 2008; U.S. application Ser. No. 12/120,275, filed May 14, 2008; and U.S. application Ser. No. 12/181,490, filed Jul. 29, 2008. The aircraft 10 may transform from a short-wingspan configuration, with the wings 12 relative short, as shown in FIGS. 1 and 2, to a long-wingspan configuration, with the wings 12 extended, as shown in FIGS. 3 and 4.

It will be appreciated that the aircraft 10 shown in FIGS. 1-4 is only one example of a wide variety of possible extendible structures. Other types of extendible or deployable structures include space structures, underwater structures, and other sorts of structures that involve telescoping members.

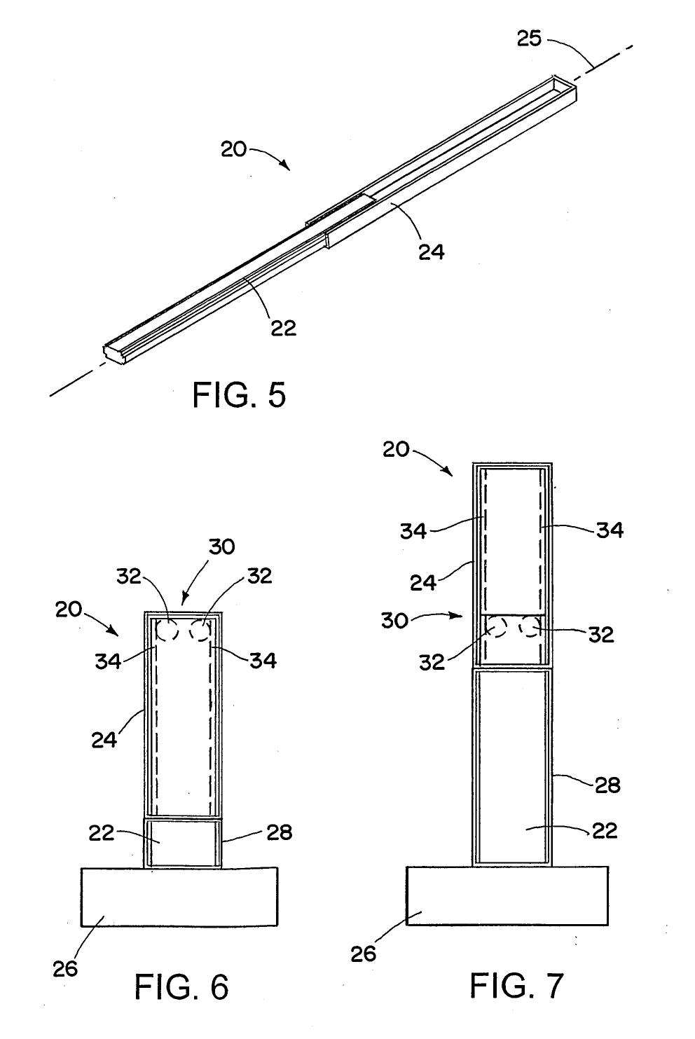

FIGS. 5-7 show a telescoping structure 20. An inboard tube 22, which has a rectangular cross section, fits into and slides relative to an outboard tube 24. The tubes 22 and 24 are shown with rectangular cross sections, but more generally may have other cross section shapes. More broadly the tubes 22 and 24 may be referred to as structure members, one of which is partially inside the other. The structure members are linked together in a telescoping arrangement, with the outer structure member 24 able to translate longitudinally (in a longitudinal direction along a longitudinal axis 25 of the structure 20) relative to the inner structure member 22. More broadly, movement of one or both of the structure members 22 and 24 causes telescoping extension or retraction of the structure 20. The inboard beam or tube 22 may be attached to a fuselage 26 of the aircraft 10, and the outboard beam or tube 24 may be free to extend or retract relative to the inboard beam or tube 22, lengthening or shortening the wing or other member. Although the structure 20 is shown with the inner structure member 22 being the inboard tube attached to the fuselage 26, it will be appreciated that alternatively the arrangement may be reversed, with the outer structure member being the inboard member that is attached to the fuselage. A morphing (flexible) skin 28 may cover all or part of the beams or tubes, and may maintain a continuous outer surface of the telescoping member 20.

The telescoping structure 20 includes an alignment mechanism 30 for maintaining the alignment of the structure members 22 and 24 as the structure 20 is extended and retracted. The alignment mechanism 30 has many possible configurations, some examples of which are described below in various embodiments. What the alignment mechanism 30 accomplishes is keeping opposite sides of the outer member 24 extending or retracting at substantially the same rate. Unbalanced forces on the structure members 22 and/or 24 could result in a tendency for one side to extend or retract at a different rate from the opposite side. Having the sides extend or retract at different rates could quickly cause jamming of telescoping structure 20. The alignment mechanism 30 prevents this sort of jamming of the structure 20.

The alignment mechanism 30 may include a pair of rotating toothed elements 32 that engage respective tooth-receiving elements 34. The toothed elements 32 may be gears or pinions, and may be on a common shaft. The tooth-receiving elements 34 may be racks or chains, with spaced recesses for receiving the teeth of the toothed elements 32. The toothed elements 32 may be on one of the structure members, such as the inner structure member 22. The tooth-receiving elements 34 may be on the other structure member, such as the outer structure member 24.

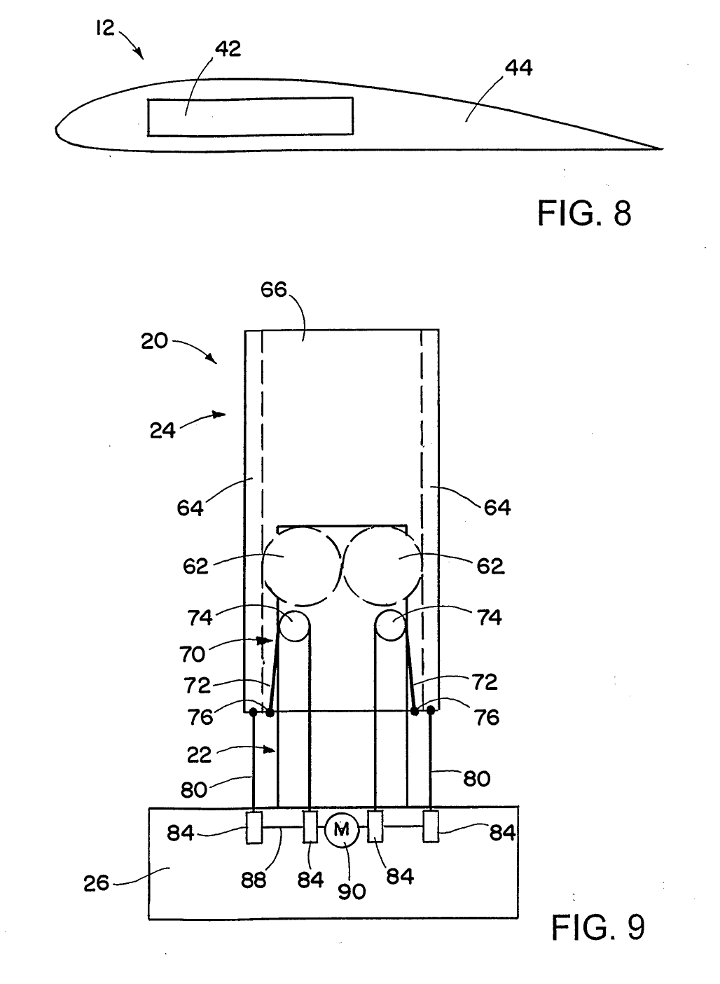

FIG. 8 shows a cross-sectional view of the wing 12, showing a central space (or cavity) 42 surrounded by a morphing material 44, such as a polymer foam or other morphing skin material. Due to the dimensions of typical airfoils, the main wing spar location may be offset from the centroid of the morphing skin material. Therefore it is difficult (if possible at all) to place the telescoping material (structure) 20 within the cavity 42 such that the telescoping member (structure) 20 does not receive significant unbalanced forces, forces that may have a tendency to bind or jam the telescoping member 20. Described below are several embodiments of alignment mechanisms 30 (FIG. 6) for ameliorating or eliminating this jamming or binding problem in telescoping members or mechanisms.

FIG. 9 shows one example, a telescoping structure 20 in which pinion gears 62 mounted to an inboard (inner) beam 22 to engage a rack or racks 64 on an inner surface 66 of an outboard (outer) beam 24. The pinion gears 62 engage the gear racks 64 on opposite sides of the beams 22 and 24, to constitute an alignment mechanism 30 of the structure 20. A cable-and-pulley system 70 is used to move the beams 22 and 24 relative to one another, to extend and retract the telescoping structure 20 shown in FIG. 9. Extension cables 72 run over pulleys 74 that are coupled to the inboard beam 22. The cables 72 have ends 76 that are attached to the outboard beam 24. Retraction cables 80 are coupled to the outboard beam 24, and are used to retract the structure 20. The pairs of extension cables 72 and retraction cables 80 are coupled to a set of four cable take-up reels 84 in the fuselage 26. The take-up reels 84 are attached to a common shaft 88 that is configured to be turned by motor 90, such as an electric motor, to extend or retract the cables 72 and 80 as appropriate to extend or retract the telescoping structure 20. The engagement of the pinion gears 62 with the rack(s) 64 keeps the inboard beam 22 from getting offset relative to the outboard beam 24. This prevents binding or jamming of the telescoping structure 20.

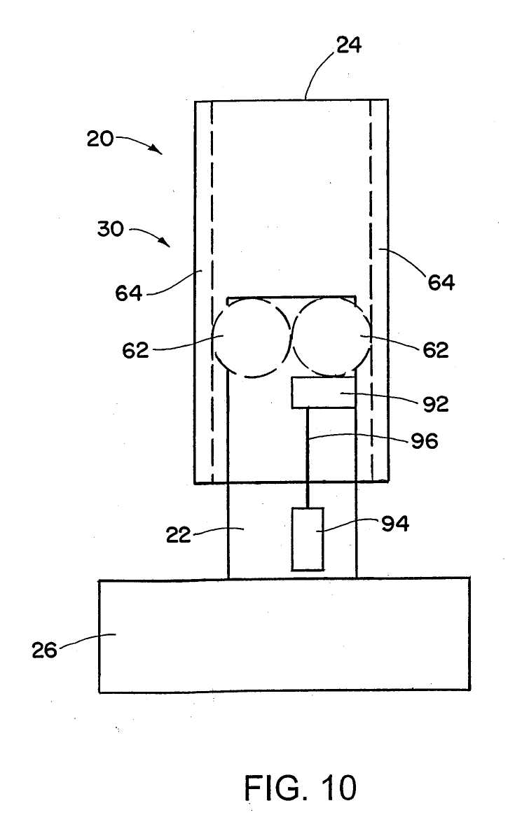

FIG. 10 shows a telescoping structure 20 that also uses pinion gears 62 on an inboard beam 22 that engage a rack or racks 64 on an inner surface 66 of an outer beam 24. The rack(s) 64 and the pinion gear(s) constitute an alignment mechanism 30. Unlike the structure of FIG. 9, the pinion gears 62 of this structure 20 do not just passively move along the rack(s) 64. Rather the pinion gears 62 are engaged and driven by a worm gear 92 that is in turn driven by a motor/gearbox/bearing 94 that is on the inboard beam 22 or the fuselage 26. A flexible shaft 96 transmits torque from the motor/gearbox/bearing 94 to the worm gear 92. As with the telescoping structure of FIG. 9, the telescoping structure in FIG. 10 prevents offset of the inboard beam relative to the outboard beam, and thus prevents binding and jamming, by engagement of the pinion gears with the rack(s).

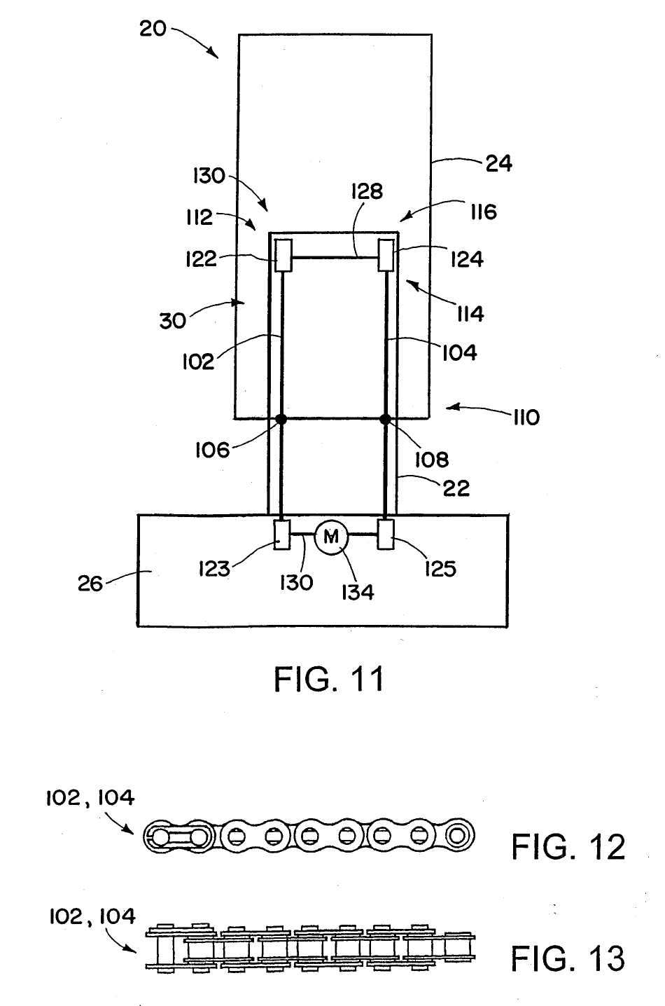

FIGS. 11-13 show another embodiment of the telescoping structure 20 which dispenses with use of a rack. A pair of chains 102 and 104 are attached to the outboard beam 24 at a pair of spaced-apart locations 106 and 108, at an end 110 of the outboard beam 24 that is closest to the fuselage 26. Each of the chains 102 and 104 wraps around a respective pair of sprockets 112 or 114, in the manner that a bicycle chain wraps around gears. The chains 102 and 104 form loops. One sprocket of each pair 112 and 114 is mounted on the inboard beam 22, at an end 116 of the inboard beam 22 away from the fuselage 26. The sprocket pair 112 includes sprockets 122 and 123, and the sprocket pair 114 includes sprockets 124 and 125. The sprockets 122 and 123 on the inboard beam 22 (one per chain) are coupled together by a connecting shaft 128. The other sprockets 123 and 125 of the pairs 112 and 114 are mounted to the fuselage 26. The fuselage sprockets 123 and 125 are also on a common shaft 130. The shaft 130 is coupled to a motor 134. Using the motor 134 to turn the fuselage sprocket shaft 130 moves the chains 102 and 104 along the sprockets 122-125. The points 106 and 108 at which the outboard beam 24 is attached to the chains 102 and 104 make a corresponding movement, extending or retracting the outboard beam 24 relative to the inboard beam 22. The engagement of the chains 102 and 104 with the sprockets 122-125, and the attachment of the outboard beam 24 to the chains 102 and 104, functions as an alignment mechanism 30 that prevents offset of the beams 22 and 24. This aids in preventing binding or jamming of the telescoping structure 20 shown in FIGS. 11-13.

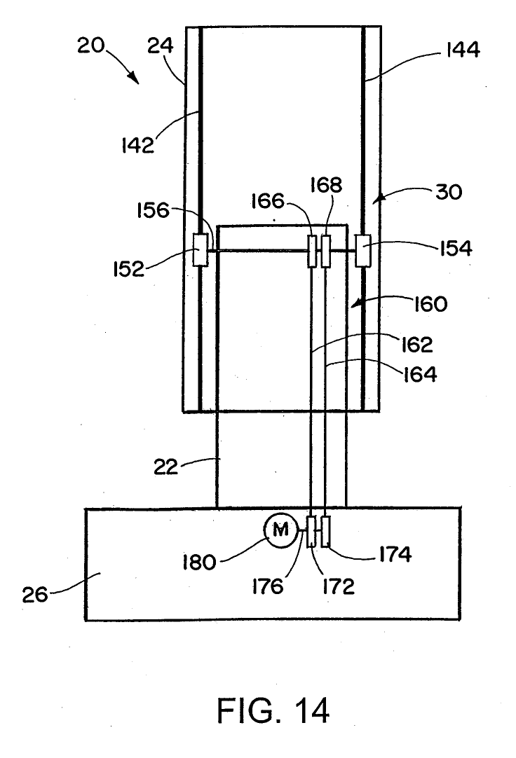

FIG. 14 shows another embodiment telescoping structure 20, in which a pair of chains 142 and 144 are bolted or otherwise attached to an inner surface of an outboard beam 24. A pair of sprockets 152 and 154 are mounted to an inboard beam 22. The sprockets 152 and 154 are connected to each other by a connecting shaft 156. The sprockets 152 and 154 engage the chains 142 and 144, thereby constituting an alignment mechanism 30 that prevents slippage or offset between the members 22 and 24 of the telescoping structure 20. The telescoping structure 20 may be extended or retracted by rotating the connecting shaft 156 and the sprockets 152 and 154, causing the chains 142 and 144 (and thus the outboard beam 24) to move along the sprockets 152 and 154. The shaft 156 is shown as being rotated by a cable drive 160 having a pair of drive cables 162 and 164 coupled to take-up spools 166 and 168 on the sprocket shaft 156, and take-up spools 172 and 174 on a motor shaft 176 of a motor 180 that may be in the fuselage 26 (or the inboard beam 22). Alternatively the sprocket shaft 156 may be turned by a variety of other mechanisms, such as a direct drive, a chain drive, or a worm gear drive.

It will be appreciated that various aspects of the various embodiments may be combined with each other where appropriate. The parts of the various structures shown may be made of suitable materials, for example suitable steel. It will be appreciated that the telescoping structure may have any of a wide variety of sizes, for example (without limitation) ranging in size from wings for unmanned aerial vehicles too small to be manned, to large space structures. The beams may have rectangular cross-sections, circular cross-sections, or cross-sections of other shapes. Different configurations may be more or less suitable for different applications.

The telescoping structures have the advantage of toothed engagement, such as between a gear or pinion and a rack or chain. This maintains the relative orientation of inboard and outboard beams, and aids in preventing binding or jamming.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A telescoping structure comprising:
an outer structure member;
an inner structure member at least partially within the outer structure member, wherein the outer structural member is translatable in a longitudinal direction relative to the outer structural member in order to extend and retract the structure; and
an alignment mechanism that is mechanically coupled to the structure members;
wherein the alignment mechanism is at least partially within the outer structural member; and
wherein the alignment mechanism maintains relative alignment of the structural members about a longitudinal axis of the telescoping structure that extends in the longitudinal direction, as the structure is extended and retracted.

2. The structure of claim 1, wherein the alignment mechanism includes one or more rotating toothed elements that engage one or more tooth-receiving elements.

3. The structure of claim 2,
wherein the one or more rotating toothed elements are coupled to and move with one of the structure members; and
wherein the one or more tooth-receiving elements are attached to and at least in part move with the other of the structure members.

4. The structure of claim 2,
wherein the one or more rotating toothed elements are coupled to and move with the inner structure member; and
wherein at least parts of the one or more tooth-receiving elements are attached to the outer structure member.

5. The structure of claim 2, wherein the one or more rotating toothed elements include a pair of pinions.

6. The structure of claim 5, wherein the pinions are attached to and rotate around a common shaft.

7. The structure of claim 2, wherein the one or more tooth-receiving elements includes a pair of chains.

8. The structure of claim 7, wherein the chains form loops.

9. The structure of claim 2, wherein the one or more tooth-receiving elements includes a pair of toothed racks.

10. The structure of claim 1, further comprising a motor coupled to the structure members, to extend and retract the structure.

11. The structure of claim 10,
wherein the alignment mechanism includes an alignment mechanism includes:
a pair of pinions coupled to a common shaft; and
a pair of tooth-receiving elements engaging respective of the pinions; and
wherein the motor is coupled to and turns the shaft.

12. The structure of claim 11, further comprising cables that transfer torque from the motor to the shaft.

13. The structure of claim 10,
wherein the alignment mechanism includes an alignment mechanism includes:
a pair of pinions; and
a pair of tooth-receiving elements engaging respective of the pinions; and
wherein the motor is coupled to and pulls the tooth-receiving elements.

14. The structure of claim 13, wherein the tooth-receiving elements include chains.

15. A method of extending a telescoping structure, the method comprising:
moving an outer structure member of the structure relative to an inner structure member of the structure; and
while doing the moving, using an alignment mechanism of the structure to keep the structure members aligned.

16. The method of claim 15, wherein the alignment mechanism includes a pair of toothed rotating members that engage a pair of tooth-receiving members of the alignment mechanism; and
wherein the using includes preventing misalignment by moving the tooth-receiving members relative to the toothed members while keeping the toothed members engaged with the tooth-receiving members.

17. The method of claim 16, wherein the moving includes using a motor to move the outer structure member relative to the inner structure member.

18. The method of claim 17, wherein the moving includes using the motor to drive at least one of the tooth-receiving members or the toothed members.

19. An aircraft wing comprising:
a morphing polymer foam body having a cavity therein; and
a telescoping structure located within the cavity;
wherein the telescoping structure includes:
an outer structure member;
an inner structure member at least partially within the outer structure member, wherein the outer structural member is translatable in a longitudinal direction relative to the outer structural member in order to extend and retract the structure; and
an alignment mechanism that is mechanically coupled to the structure members;
wherein the alignment mechanism is at least partially within the outer structural member; and
wherein the alignment mechanism maintains relative alignment of the structural members about a longitudinal axis of the telescoping structure that extends in the longitudinal direction, as the structure is extended and retracted.

20. The aircraft wing of claim 19, wherein at least one of a foam centroid or a skin centroid of the wing is outside of the cavity.
